(19) United States
(12) Patent Application Publication
(10) Pub. No.: US 2016/0352600 A1
(43) Pub. Date: Dec. 1, 2016

(54) ABNORMALITY DETECTION METHOD, ABNORMALITY DETECTION DEVICE, AND NETWORK SYSTEM

(71) Applicant: Hitachi, Ltd., Tokyo (JP)

(72) Inventors: Yuncheng ZHU, Tokyo (JP); Hideki OKITA, Tokyo (JP)

(73) Assignee: Hitachi, Ltd., Tokyo (JP)

(21) Appl. No.: 15/164,093

(22) Filed: May 25, 2016

(30) Foreign Application Priority Data
May 29, 2015 (JP) 2015-109314

(51) Int. Cl. H04L 12/26

(52) U.S. Cl. CPC H04L 43/0817; H04L 43/10; H04L 43/16; H04L 43/065

(57) ABSTRACT

In a network system including a plurality of pieces of network equipment, detection of a piece of network equipment in which an abnormality occurs is made possible. In the network system including the pieces of network equipment, index values indicating operation states of the pieces of network equipment such as data-plane index values are acquired from the respective pieces of network equipment via communication media, high-frequency components of the acquired index values are calculated, and the abnormality in the piece of network equipment is detected based on a correlation of the high-frequency components.

### CLAIM OF PRIORITY

The present application claims priority from Japanese application JP 2015-109314 filed on May 29, 2015, the content of which is hereby incorporated by reference into this application.

### BACKGROUND OF THE INVENTION

Field of Invention

The disclosed subject matter relates to a technique for analyzing a communication network.

Description of the Related Art

A large-scale communication network formed by a plurality of pieces of network equipment has become a part of social infrastructure. In this communication network, an abnormality called a “silent failure” may occur that cannot be detected by an autonomic diagnosis function prepared in the network equipment. Thus, a communication operator needs early detection of abnormalities in the network equipment, including the silent failure, to take measures for retaining reliability of the communication network.

The first technique for detecting the abnormalities in the network equipment is a method that detects a rapid change in the traffic amount as an abnormality. Japanese Unexamined Patent Application Publication No. 2008-211541 discloses, as the method for detecting the rapid chance in the amount of traffic on a network, a method for converting traffic time series data into compensated time series data that can be easily detected by using a noise filter and comparing the compensated time series data with an automatically set threshold value to detect the abnormality.

The second technique for detecting the abnormalities in the network equipment is a method that compares a correlation of pieces of information indicating operation states of a monitored terminal with a determination criterion. Japanese Unexamined Patent Application Publication No. 2011-034319 discloses, as a system for detecting an operation abnormality in a processing operation in a computer terminal, a system that acquires hardware operation-state information and software operation-state information of the terminal and determines whether or not a correlation of the acquired pieces of operation-state information is different from preset operation-state relation information, thereby detecting the abnormality.

### SUMMARY OF THE INVENTION

However, the first technique can detect the rapid change appearing when the abnormality of the equipment occurs, but can hardly detect a change within a range of daily variations that is an early feature of the abnormality.

Further, according to the second technique, it is necessary to find out the operation principle of the monitored terminal and preset the operation-state relation information. Therefore, the second technique can be applied only to pieces of equipment for which a relation of operation states is clear, and it is difficult to detect the abnormality in pieces of network equipment in a large-scale communication network for which mutual relations of operation states are complicated.

The present specification discloses a detection device in a network system including a plurality of pieces of network equipment, which detects a change within a range of daily variations of the pieces of network equipment to detect a piece of network equipment (i.e., a router) in which an abnormality has occurred with high accuracy.

The brief description of the summary of typical one of the invention disclosed in the present application is as follows.

An abnormality detection method in a network system including a plurality of pieces of network equipment acquires index values indicating operation states of the pieces of network equipment from the pieces of network equipment, respectively, calculates high-frequency components of the index values, and detects an abnormality in the pieces of network equipment based on a correlation between the high-frequency components.

Further, an abnormality detection device in a network system including a plurality of pieces of network equipment acquires index values indicating operation states of the pieces of network equipment from the pieces of network equipment, respectively, calculates high-frequency components of the index values, and detects an abnormality in the pieces of network equipment based on a correlation between the high-frequency components.

Furthermore, a network system includes a plurality of pieces of network equipment and an abnormality detection device, wherein the abnormality detection device acquires index values indicating operation states of the pieces of network equipment from the pieces of network equipment, respectively, calculates high-frequency components of the index values, and detects an abnormality in the pieces of network equipment based on a correlation between the high-frequency components.

According to the disclosure, it is possible to detect, in the network system including the pieces of network equipment, a piece of equipment in which the abnormality has occurred with high accuracy.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a system configuration in a first embodiment;

FIG. 2 shows a configuration example of an abnormality detection device in the first embodiment;

FIG. 3 shows an example of an index-value information table in the first embodiment;

FIG. 4 shows an example of an index-value history table in the first embodiment;

FIG. 5 shows an example of a high-frequency component history table in the first embodiment;

FIG. 6 shows an example of an index-value group information table in the first embodiment;

FIG. 7 shows an example of a process flow of an abnormality analysis program in the first embodiment;

FIG. 8 shows an example of a correlation-degree information table in the first embodiment;

FIG. 9 shows an example of a system configuration second embodiment; and

FIG. 10 shows an example of a system configuration in a third embodiment.

### DETAILED DESCRIPTION OF THE INVENTION

Embodiments of the present invention are described below, referring to the drawings.

In the following embodiments, description is divided into a plurality of sections or embodiments when necessary for the sake of convenience. However, the divided descriptions are not mutually unrelated unless specifically stated. One of the descriptions corresponds to a variation, details, or supplementary description, for example, of a portion or all of another description.

Further, when the number of elements or the like (including the number of items, a numerical value, the quantity, a range, and the like) is referred to in the following embodiments, the number of elements is not limited to a specific number but may be larger than or equal to or smaller than or equal to the specific number, unless specifically stated and the number of elements is apparently limited to the specific number in principle, for example.

Furthermore, an element (including an element step, for example) in the following embodiments is not necessarily essential, unless specifically stated and the element is considered to be apparently essential in principle, for example.

Each of the following embodiments can be applied alone, or more than one or all of the embodiments can be applied in combination.

### First Embodiment

The present embodiment has a feature that, in a network system including a plurality of pieces of network equipment, a detection server acquires index values for the respective pieces of network equipment via communication media, calculates high-frequency components by using the acquired index values, and detects an abnormality in the pieces of network equipment based on a correlation of the calculation results.

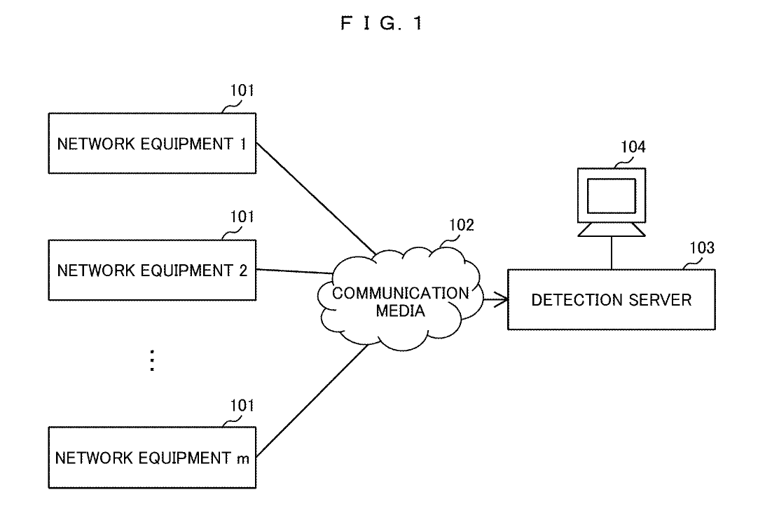

A system in the present embodiment is configured to include a plurality of pieces of network equipment 101 (hereinafter, NE), communication media 102 for acquiring an index value, a detection server 103 (which can also be called an abnormality detection device), and a display device 104, as shown in FIG. 1. The detection server 103 acquires a plurality of index values indicating operation states from the plural pieces of NE 101 via the communication media 102 and detects whether or not an abnormality occurs in each piece of NE. The detection server 103 provides the detected result of abnormality occurrence to the display device 104. The communication media 102 may be a simple communication path or an NE management server (NEM) that acquires the index values from the plural pieces of NE 101 and informs the detection server 103 of the acquired index values collectively. The communication media 102 may include a piece of equipment that is connected to a communication network, for example, a router, a switch, and a terminal.

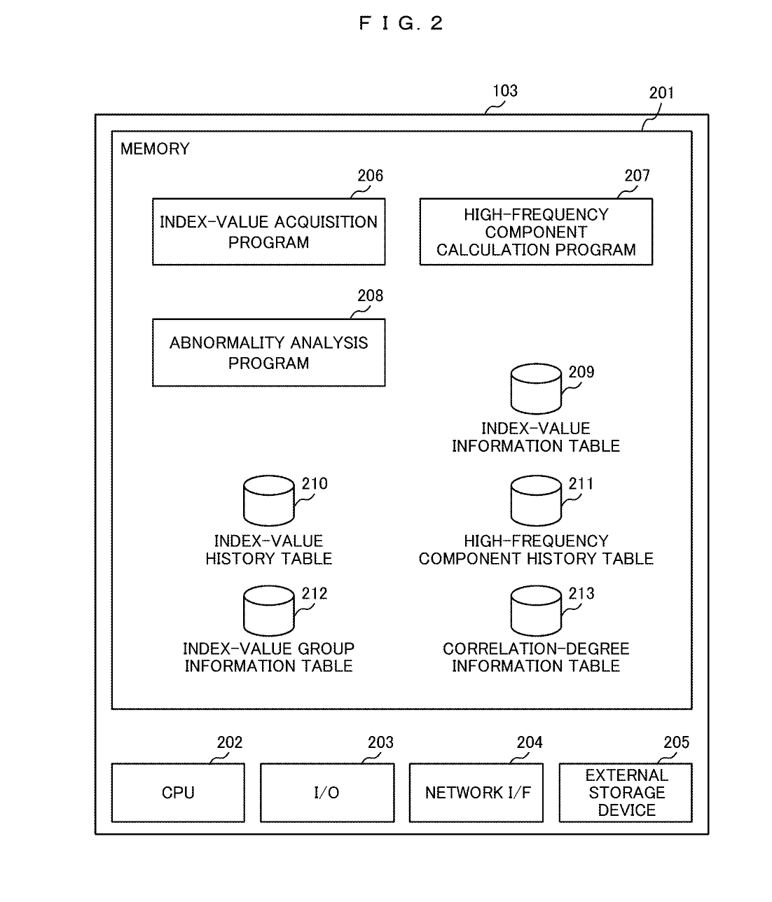

FIG. 2 shows a configuration example of the detection server 103 in the present embodiment. Programs stored in an external storage device 205 of a general computer are expanded on a memory 201 and executed by a CPU 202, so that the function of the detection server 103 in the present embodiment is achieved. The detection server 103 connects with the communication media 102 and the display device 104 via an input/output interface 203 and/or a network interface 204.

The memory 201 of the detection server 103 stores an index value acquisition program 206, a high-frequency component calculation program 207, and an abnormality analysis program 208 therein. Further, the memory 201 of the detection server 103 stores therein an index-value information table 209 storing a list of index values used for detection, an index-value history table 210 storing acquired index values, a high-frequency component history table 211 storing values of high-frequency components calculated from the index values, an index-value group information table 212 storing grouping information of the index values, and a correlation-degree information table 213 storing a calculated value of correlation information.

The configuration in which the above programs and the above pieces of information are stored on the memory of a single computer is described in the present embodiment. However, a configuration can also be employed in which the above pieces of information are stored in the external storage device, read from the above external storage device in every process of the programs, and stored into the external storage device every time each process is completed.

Further, the above programs and the above pieces of information can be stored in a plurality of computers in a distributed manner. For example, the above pieces of information can be respectively implemented as tables of a relational database and be stored in a database server different from the detection server 103, so that the above programs executed on the detection server 103 refers to and updates the above pieces of information on the database server.

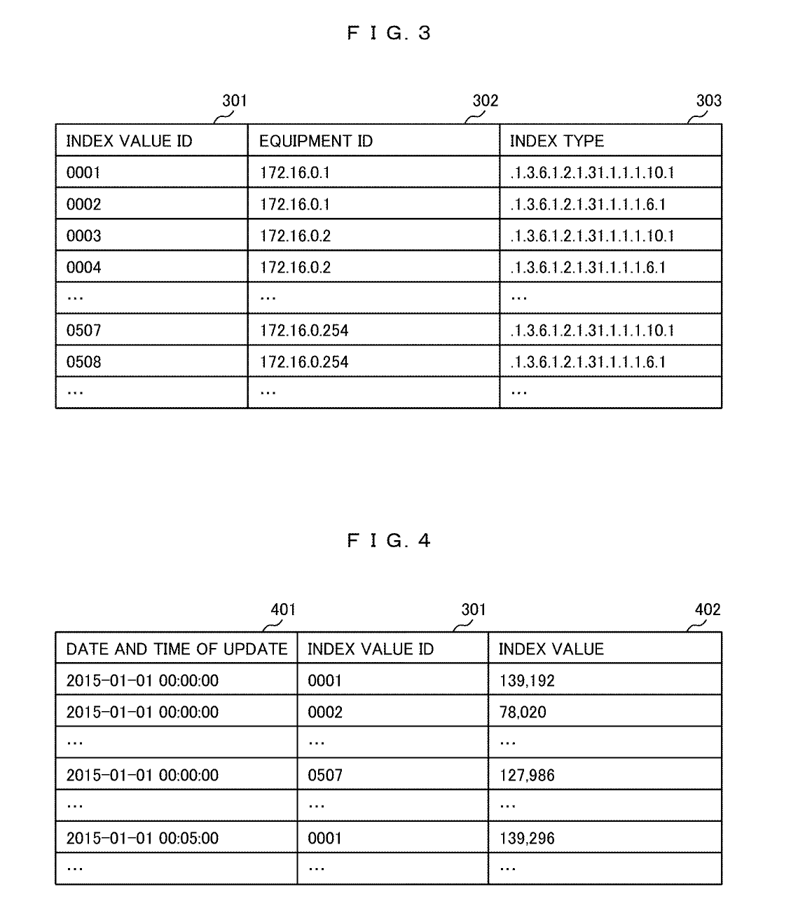

FIG. 3 shows an example of the index-value information table 209 retained by the detection server 103. Index-value information includes an index value ID 301 indicating an identifier of an index value, an equipment ID 302 indicating an identifier of a piece of equipment from which the index value is acquired, and an index type 303 indicating the meaning of the index value in the inside of that piece of equipment. The index value shows an operation state of a piece of network equipment 101. In the example of FIG. 3, a number with numerals is employed as the index value ID 301, an equipment address is employed as the equipment ID 302, and a standard description of Management Information Base (MIB) defined in RFC2578 by Internet Engineering Task Force (IETF) is employed as the index type 303. “.1.3.6.1.2.1.31.1.1.1.10.1” and “.1.3.6.1.2.1.31.1.1.1.6.1” respectively mean the number of transmitted octets and the number of received octets in Interface #1. Other than those, each item in the index-value information table 209 can use another given character string that can be used as an identifier.

The index value acquisition program 206 repeatedly acquires index values of the respective pieces of NE based on information acquired from the index-value information table 209 via the communication media 102, for example, with a preset constant time interval. The index value is a value corresponding to the index type 303. For example, the index value of the index value ID 0001 is the number of transmitted octets, and the index value of the index value ID 0002 is the number of received octets. The index value acquisition program 206 stores the acquired index values in the index-value history table 210.

FIG. 4 shows an example of the index-value history table 210 retained by the detection server 103. An index-value history includes a date and time of update 401 indicating an updated time of the history, an index value ID 301 indicating an identifier of an index value, and an index value 402 indicating a value of the index value at the date and time of update.

The high-frequency component calculation program 207 calculates high-frequency components of respective index values based on the stored index-value history every time the index-value history table 210 is updated. In an example of a calculation method, the high-frequency component calculation Program 207 obtains smoothed normalized rates of variability represented by the following Expression 1 for a plurality of index values having the same index value ID by using a high-pass filter. In Expression 1, xₜ represents an index value at time t, n represents a smoothing length, and a represents smoothness.

$$F ( {x}_{t} ) = \frac{{x}_{t} - \frac{{α}^{n} - 1}{{α}^{n - 1} ( α - 1 )} {\sum }_{k = 1}^{n} \frac{1}{{α}^{k - 1}} {x}_{t - k}}{\frac{1}{2} ( {x}_{t} + \frac{{α}^{n} - 1}{{α}^{n - 1} ( α - 1 )} {\sum }_{k = 1}^{n} \frac{1}{{α}^{k - 1}} {x}_{t - k} )} ( α > 1 ) \qquad [ Expression 1 ]$$

The high-frequency component calculation program 207 stores the calculated high-frequency components in the high-frequency component history table 211.

FIG. 5 shows an example of the high-frequency component history table 211 retained by the detection server 103. A high-frequency component history includes a time and date of update 401 indicating an updated time of the history, an index value ID 301 indicating an identifier of an index value, and a high-frequency component 501 indicating a value of the high-frequency component calculated for the index value at the date and time of update.

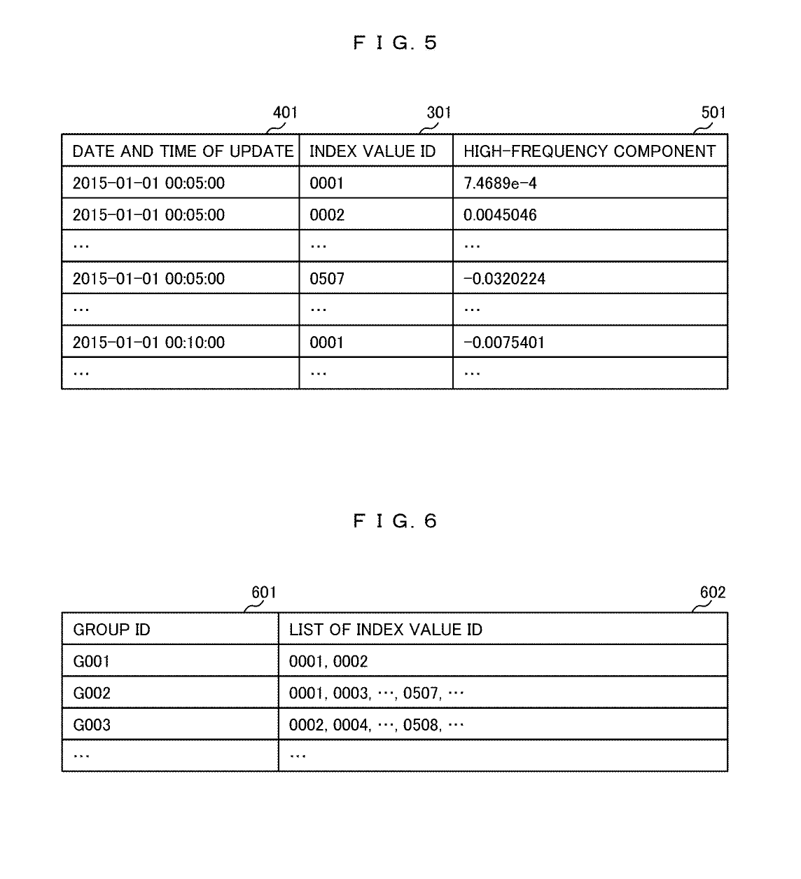

FIG. 6 is an example of the index-value group information table 212 retained by the detection server 103. The index-value group information table 212 is referred to in calculation of a degree of unbalance of a high-frequency component, as described later. A plurality of index values belonging to the same group may have a strong correlation or a weak correlation. Index-value group information includes a group ID 601 indicating an identifier of a group, and a list of index value IDs 602 indicating a list of identifiers of index values included in the group. The index-value group information can be preset manually, or can be automatically generated by using the information in the index-value information table 209. Examples of a method for automatically generating the index-value group include grouping of index values having the same equipment ID 302, grouping of index values having the same index type 303, grouping of index values that are the same in a portion of the index type 303, grouping of index values of a portion of connected equipment by using a relation of connection of NE, and grouping of index values at random.

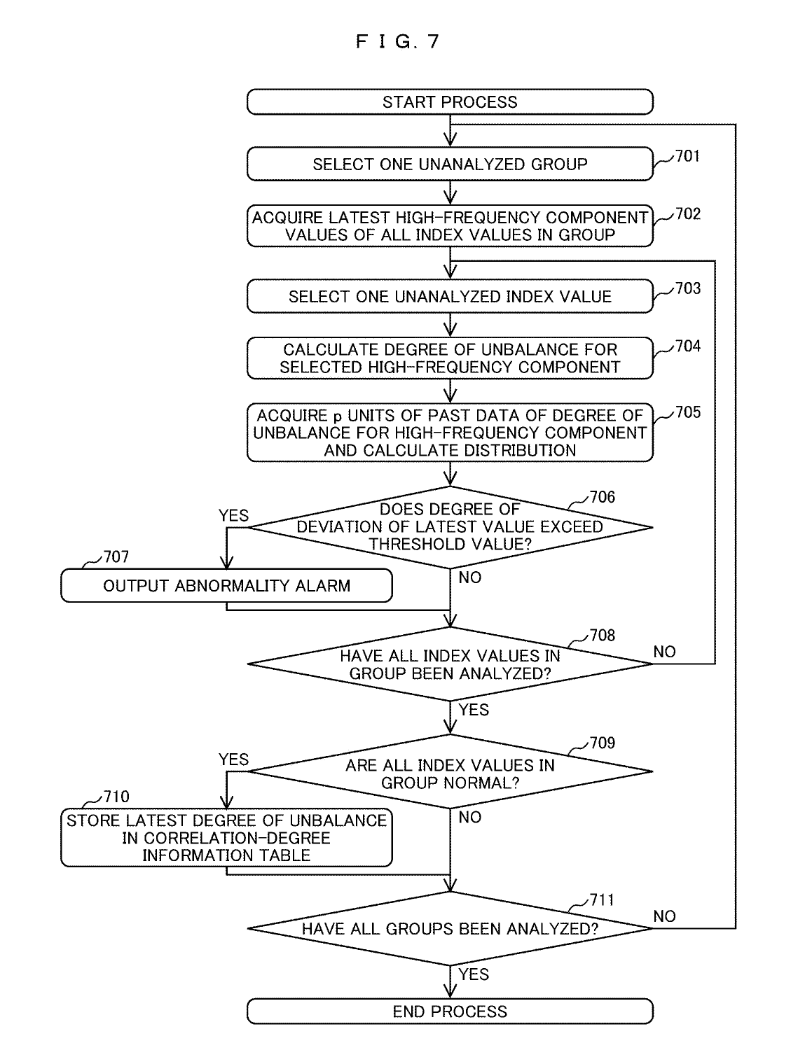

FIG. 7 shows a specific example of a process flow of the abnormality analysis program 208 performed by the detection server 103. In Step 701, the detection server 103 selects one unanalyzed group from the index-value group information table 212. Then, the detection server 103 acquires latest high-frequency components of all index values included in the group selected in Step 701 from the high-frequency component history table 211 in Step 702. The detection server 103 selects one unanalyzed index value in the selected group in Step 703. Then, in Step 704, the detection server 103 calculates a degree of unbalance of the high-frequency component as a correlation between the index value selected in Step 703 and the other index values in the group. The degree of unbalance is calculated based on a difference between the high-frequency component of the selected index value and an average value of the high-frequency components of the other index values. Assuming the high-frequency component of the i-th index value as z(i), the degree of unbalance of the i-th index value in a group including m index values is represented by the following Expression 2.

$$G ( z ( i ) ) = z ( i ) - \frac{{\sum }_{j = 1}^{m} z ( j ) - z ( i )}{m - 1} \qquad [ Expression 2 ]$$

In step 705, the detection server 103 acquires p units of data as a past history of the degrees of unbalance having the same index value ID and the same group ID from the correlation-degree information table 213 and calculates a statistical distribution of the degrees of unbalance on the history. Then, in Step 706, the detection server 103 calculates an outside probability in the latest statistical distribution of the degrees of unbalance on the history, as a degree of deviation, and determines whether or not the degree of deviation exceeds a preset threshold value. In the case where the degree of deviation exceeds the threshold value, the detection server 103 outputs an abnormality alarm to the display device 104 in Step 707. As an example of output contents, a combination of the index value ID 301, the equipment ID 302 indicating the identifier of the piece of equipment associated with that index value, the index type 303 indicating the meaning of the index value inside that piece of equipment, and the degree of deviation of the degree of unbalance can be output to the display device 104. Then, the detection server 103 determines whether or not analysis of all the index values in the group selected in Step 701 has been completed in Step 708. In the case where the analysis has not been completed, the detection server 103 returns to Step 703 and analyzes a next index value. In the case where the analysis has been completed, the detection server 103 goes to Step 709 and determines whether or not all the index values in the Group are normal. In the case where all the index values are normal, the detection server 103 stores the latest values of the degree of unbalance in the group for all the analyzed index values, in the correlation-degree information table 213 in Step 710. Then, the detection server 103 determines whether or not all groups have been analyzed in Step 711. In the case where analysis of all the groups has not been completed, the detection server 103 returns to Step 701 and analyzes a next group.

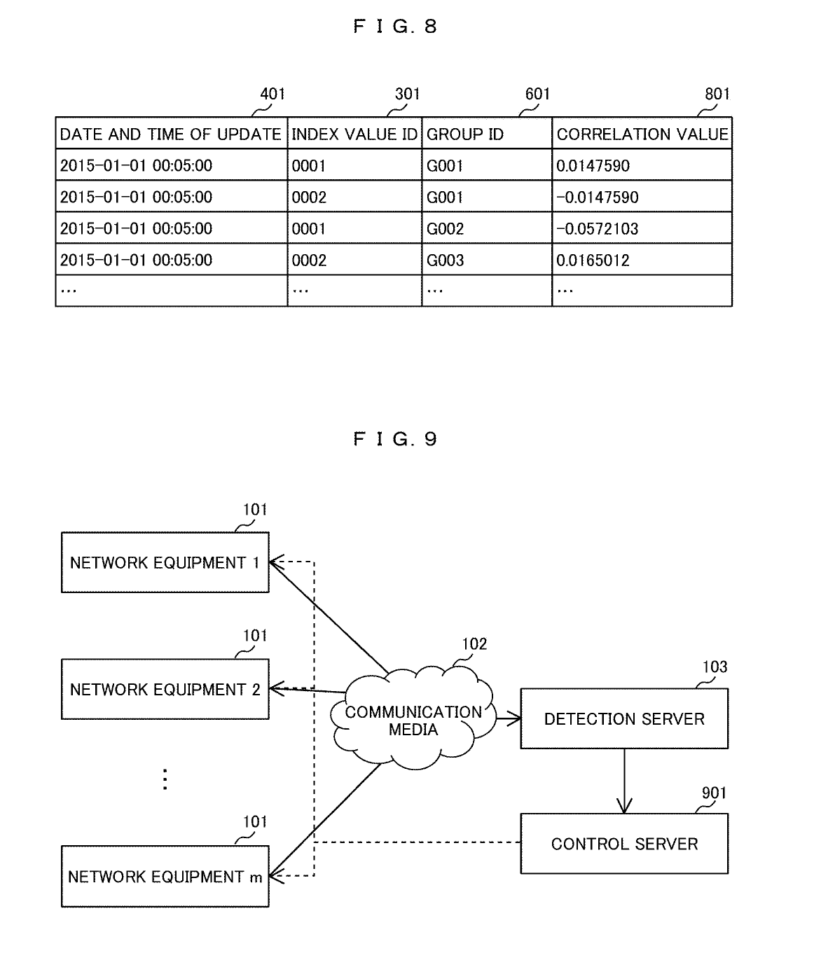

FIG. 8 shows an example of the correlation-degree information table 213 retained by the detection server 103. Correlation-degree information includes a date and time of update 401 indicating an updated time of a degree of correlation, an index value ID 301 indicating an identifier of an index value, a group ID 601 indicating an identifier of a group for which the degree of correlation is calculated, and a correlation value 801 indicating the calculation result of the degree of correlation at the date and time of update.

As described above, in the present embodiment, in the network system including the plural pieces of network equipment, the detection server acquires the index values of the plural pieces of network equipment via the communication media. The detection server calculates the smoothed normalized rates of variability as the high-frequency components from the acquired index values. The detection server calculates the degree of deviation of the latest degree of correlation of the index values based on the degree of unbalance of the calculated results within the group. Then, the detection server determines whether or not any abnormality occurs in the pieces of network equipment by using the degree of deviation of the degree of correlation. Thus, it is possible to detect a change within a range of daily variations, which is an early feature of an abnormality, and to detect the abnormality in a network with high accuracy.

Further, the detection server 103 uses the smoothed normalized rate of variability as the high-frequency component of the index value. With the smoothed normalized rate of variability, a bandwidth to be processed can be smoothly adjusted as compared with a difference or another high-pass filter, and it is possible to take appropriate information into analysis. In the case where the parameter n is larger than a, the smoothed normalized rate of variability can be calculated approximately with a high speed by calculation represented by the following Expression 3. Further, the calculation of the smoothed normalized rate of variability can be configured by using a finite impulse response filter (FIR filter) and can be therefore implemented by hardware easily.

$$\{ \begin{matrix}{y}_{0} = 0 \\ {y}_{t} = \frac{1}{α} ( {y}_{t - 1} + ( α - 1 ) {x}_{t - 1} ) \\ F ( {x}_{t} ) = \frac{{x}_{t} - {y}_{t}}{2 ( {x}_{t} + {y}_{t} )}\end{matrix} \qquad [ Expression 3 ]$$

The detection server 103 detects the abnormality in the pieces of network equipment by using the degree of unbalance within the group of each of the high-frequency components of the plural index values. Thus, even in the case where the high-frequency component of the index value of one piece of NE falls within the past history when the abnormality occurs, unbalance occurs with respect to the index values and the high-frequency components of the other pieces of NE that are correlated, for example, are in parallel with that piece of NE, and therefore the abnormality can be detected.

Further, the detection server 103 compares the calculated degree of unbalance with the statistical distribution generated from the p units of data in the past history, and detects the abnormality in the pieces of network equipment by using the degree of deviation. That is, because a variance of the statistical distribution generated from the past history is small between the index values having a strong correlation, there is high sensitivity to an outlier. Therefore, for the index values having a known correlation, an operator can perform manual setting in advance in such a manner that those index values belong to the same group. Meanwhile, in a complicated, large-scale communication network, a relation between the index values is often unclear and therefore manual grouping is difficult. Thus, the detection server 103 can perform grouping of index values in an arbitrary manner and detect the abnormality in the pieces of network equipment by using that grouping. This is because an outlier is hardly generated between index values having a weak correlation because of a large variance of the statistical distribution generated from the past history. Thus, it is not necessary to find out the principle of correlation between the index values for grouping of the index values, and the abnormality in the network equipment can be detected without adversely affecting the detection accuracy.

The present embodiment uses the numbers of octets transmitted and received by the network equipment as the index values. However, other than such data-plane index values, it is possible to use an index value indicating the operation state of the network equipment, for example, a control-plane index value such as the number of connected users, a software index value such as a CPU or memory usage, and other index values.

### Second Embodiment

The present embodiment has the following feature. In a network system including a plurality of pieces of network equipment, a detection server acquires index values of the respective pieces of network equipment via communication media. The detection server calculates high-frequency components from the acquired index values, and detects an abnormality in the pieces of network equipment based on a correlation of the calculation results. Upon detection of the abnormality in the pieces of network equipment, the detection server requests a control device controlling a network to verify an abnormal state for a specific piece of equipment. Then, the control device requests control to the piece of equipment in which the abnormality occurs in a manner that the abnormality is eliminated. Therefore, it is possible to automate elimination of the abnormality in the network in the present embodiment.

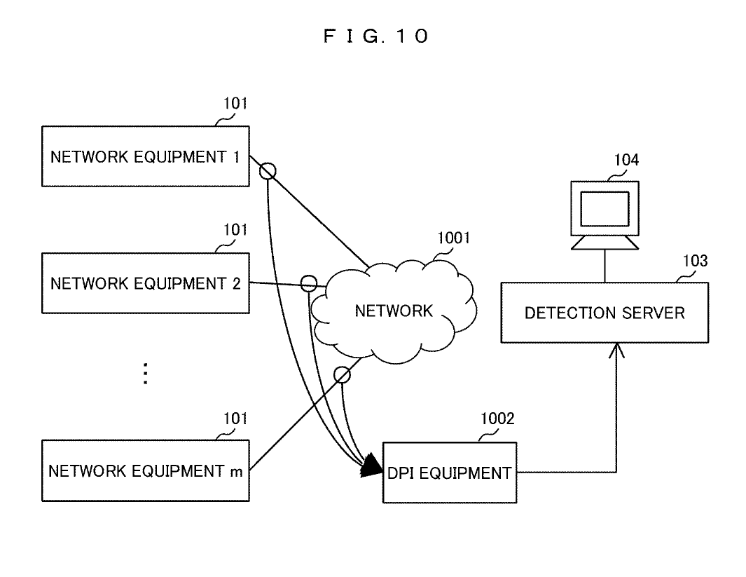

A system configuration in the present embodiment is described, referring to FIG. 9. The overlapping descriptions with the first embodiment are omitted. In the system configuration in the present embodiment, a control server 901 (this can also be called a network control device) is provided, which is connected to the NE 101 and the detection server 103. Upon detection of an abnormality from a network, the detection server 103 requests verification of the abnormality and control to the control server 901. When receiving the request, the control server 901 verifies the abnormality for the NE 101. As an example of a method for abnormality verification, a known method can be used that transmits test traffic or a test connection request, for example. In the case where the abnormality in the NE 101 has been determined in the abnormality verification, the control server 901 transmits a control instruction to the NE 101 and requests control to eliminate the abnormality. As an example of a method for elimination of the abnormality, a known method can be used that changes a traffic path and resets the NE 101 in which the abnormality occurs, for example.

### Third Embodiment

The present embodiment has a feature that, in a network system including a plurality of pieces of network equipment, a detection server acquires statistics of traffic flowing on links connecting with pieces of network equipment as index values, calculates high-frequency components from the acquired index values, and detects an abnormality in the pieces of network equipment based on a correlation of the calculation results.

A system configuration in the present embodiment is described, referring to FIG. 10. The overlapping descriptions with the first embodiment are omitted. In the system configuration in the present embodiment, a plurality of pieces of NE 101 are connected to a communication network 1001. Deep packet inspection equipment (hereinafter, DPI) 1002 monitors each of interfaces connecting the pieces of NE 101 and the communication network 1001. The DPI 1002 transfers statistical information on transmitted and received traffic acquired at the interfaces to the detection server 103. The detection server 103 uses the statistical information on the transmission and reception acquired from the DPI 1002 to acquire an equipment ID 302 and an index value 402. The detection server 103 then uses the acquired information to detect an abnormality in network equipment in the manner described in the first embodiment.

As described above, the index values are acquired by using the DPI 1002 in the present embodiment. Thus, even in the case where the piece of NE 101 does not have a function of generating and transmitting the index value or has lost that function, it is possible to detect the abnormality in the network equipment.

Although the present disclosure has been described with reference to exemplary embodiments, those skilled in the art will recognize that various changes and modifications may be made in form and detail without departing from the spirit and scope of the claimed subject matter.

What is claimed is:

1. An abnormality detection method in a network system including a plurality of pieces of network equipment, comprising:
repeatedly acquiring, from the respective pieces of network equipment, index values indicating operation states of the respective pieces of network equipment;
calculating, from the index values of the respective pieces of network equipment, high-frequency components of the index values; and
detecting an abnormality in a target piece of network equipment based on a correlation of the high-frequency components of the pieces of network equipment.

2. The abnormality detection method of claim 1,
wherein the high-frequency components are calculated for the index values by using a high-pass filter.

3. The abnormality detection method of claim 2,
wherein the high-pass filter calculates smoothed normalized rates of variability from a history of the index values, as the high-frequency components.

4. The abnormality detection method of claim 1,
wherein the correlation is a degree of unbalance calculated from a difference between a target one of the high-frequency components of the pieces of network equipment and an average value of another one or more of the high-frequency components of one of more of the pieces of the network equipment.

5. The abnormality detection method of claim 4,
wherein a statistical distribution of the degrees of unbalance is calculated from a history of the degree of unbalance,
an outside probability of a latest degree of unbalance is calculated in the statistical distribution, and
the outside probability is compared with a preset threshold value to detect the abnormality in the target piece of network equipment.

6. An abnormality detection device in a network system including a plurality of pieces of network equipment:
repeatedly acquiring, from the respective pieces of network equipment, index values indicating operation states of the respective pieces of network equipment;
calculating, from the index values of the respective pieces of network equipment, high-frequency components of the index values; and
detecting an abnormality in a target piece of network equipment based on a correlation of the high-frequency components of the pieces of network equipment.

7. The abnormality detection device of claim 6,
wherein the high-frequency components are calculated for the index values by using a high-pass filter.

8. The abnormality detection device of claim 7,
wherein the high-pass filter calculates smoothed normalized rates of variability from a history of the index values, as the high-frequency components.

9. The abnormality detection device of claim 6,
wherein the correlation is a degree of unbalance calculated from a difference between a target one of the high-frequency components of the pieces of network equipment and an average value of another one or more of the high-frequency components of one of more of the pieces of the network equipment.

10. The abnormality detection device of claim 9,
wherein a statistical distribution of the degrees of unbalance is calculated from a history of the degree of unbalance,
an outside probability of a latest degree of unbalance is calculated in the statistical distribution, and
the outside probability is compared with a preset threshold value to detect the abnormality in the target piece of network equipment.

11. A network system comprising a plurality of pieces of network equipment and an abnormal detection device,
wherein the abnormality detection device:
repeatedly acquires, from the respective pieces of network equipment, index values indicating operation states of the respective pieces of network equipment,
calculates, from the index values of the respective pieces of network equipment, high-frequency components of the index values; and
detects an abnormality in a target piece of network equipment based on a correlation of the high-frequency components of the pieces of network equipment.

12. The network system of claim 11,
wherein the abnormality detection device calculates the high-frequency components for the index values by using a high-pass filter.

13. The network system of claim 12,
wherein the high-pass filter calculates smoothed normalized rates of variability from a history of the index values, as the high-frequency components.

14. The network system of claim 11,
wherein the correlation is a degree of unbalance calculated from a difference between a target one of the high-frequency components of the pieces of network equipment and an average value of another one or more of the high-frequency components of one of more of the pieces of the network equipment.

15. The network system of claim 14,
wherein the abnormality detection device:
calculates a statistical distribution of the degrees of unbalance from a history of the degree of unbalance,
calculates an outside probability of a latest degree of unbalance in the statistical distribution, and
compares the outside probability with a preset threshold value to detect the abnormality in the target piece of network equipment.

16. The network system of claim 11, further comprising an inspection device that monitors an interface connecting the pieces of network equipment and a communication network,
wherein the inspection device transmits statistical information on transmitted and received traffics acquired from the interfaces to the abnormal detection device, and
the abnormal detection device acquires the index values based on the statistical information on the transmitted and received traffics.

17. The network system of claim 11, further comprising a control device controlling the pieces of network equipment,
wherein the abnormal detection device requests, to the control device, verification of an abnormal state for one of the pieces of network equipment in which the abnormality is detected, or the verification of the abnormal state for the one of the pieces of network equipment in which the abnormality is detected, and control.
